(19) United States
(12) Patent Application Publication
(10) Pub. No.: US 2015/0280805 A1
(43) Pub. Date: Oct. 1, 2015

(54) SYSTEMS AND METHODS OF FACILITATING PORTABLE DEVICE COMMUNICATIONS

(71) Applicant: GM GLOBAL TECHNOLOGY OPERATIONS LLC, Detroit, MI (US)

(72) Inventors: KOBI JACOB SCHEIM, PARDESS HANNA (IL); NADAV LAVI, RAMAT-HASHARON (IL)

(73) Assignee: GM GLOBAL TECHNOLOGY OPERATIONS LLC, Detroit, MI (US)

(21) Appl. No.: 14/228,467

(22) Filed: Mar. 28, 2014

(51) Int. Cl. H04B 7/155; H04W 52/46

(52) U.S. Cl. CPC H04B 7/155; H04W 52/46

(57) ABSTRACT

Methods and systems are provided for facilitating communication. The system includes a portable device and a base station. The system also includes a vehicle-based device configured to communicate wirelessly via a first communications link with the portable device, communicate via a second communications link with the base station, and relay data between the first communications link and the second communications link. The portable device is configured to determine a quality of the first communications link and reduce an emitted power in response to the quality of the first communications link being higher than a predetermined threshold.

### TECHNICAL FIELD

The technical field generally relates to radio communications, and more particularly relates to radio communications with vehicle-based repeaters.

### BACKGROUND

Communication with portable cellular telephones (“portable device”) is often problematic due to any number of technical and environmental factors. For instance, in urban areas, buildings often block radio frequency (“RF”) signals that are emitted between the portable device and a base station, which may prevent a communications link from being established or may lead to a low quality link. Furthermore, even if a communications link is established, the portable device often must operate at or near a maximum emitted power. Such prolonged operation may lead to premature battery drainage which, of course, requires frequent battery charging and excessive electricity usage.

Accordingly, it is desirable to provide a system and method for providing a high quality communications link between the portable device and the base station. In addition, it is desirable to provide a system and method to reduce the power emitted by the portable device. Furthermore, other desirable features and characteristics of the present invention will become apparent from the subsequent detailed description and the appended claims, taken in conjunction with the accompanying drawings and the foregoing technical field and background.

### SUMMARY

In one embodiment, a system is provided for facilitating communication. The system includes a portable device and a base station. The system also includes a vehicle-based device configured to communicate wirelessly via a first communications link with the portable device, communicate via a second communications link with the base station, and relay data between the first communications link and the second communications link. At least one of the portable device, the base station, and the vehicle-based device is configured to determine a quality of the first communications link. The portable device is also configured to reduce an emitted power in response to the quality of the first communications link being higher than a predetermined threshold.

In another embodiment, a method is provided for facilitating communications. The method includes establishing a first communications link between a portable device and a vehicle-based device and establishing a second communications link between the vehicle-based device and a base station. The method also includes relaying data between the first communications link and the second communications link. The method further includes determining a quality of the first communications link and the second communications link. The method also includes reducing an emitted power of the portable device in response to the quality of the first communications link and the second communications link being higher than a predetermined threshold.

In another embodiment, the method includes establishing a first communications link between a portable device and a vehicle-based device, establishing a second communications link between the vehicle-based device and a base station, and establishing a third communications link between the portable device and the base station. The method further includes relaying data between the first communications link and the second communications link. The method also includes determining a power requirement of the portable device utilizing the first communications link and determining a power requirement of the portable device utilizing the third communications link. The first communications link is terminated in response to the power requirement of the portable device utilizing the first communications link being greater than the power requirement of the portable device utilizing the third communications link. The third communications link is terminated in response to the power requirement of the portable device utilizing the third communications link being greater than the power requirement of the portable device utilizing the first communications link.

### DESCRIPTION OF THE DRAWINGS

The exemplary embodiments will hereinafter be described in conjunction with the following drawing figures, wherein like numerals denote like elements, and wherein:

FIG. 1 is a block schematic diagram of a system for facilitating communications in accordance with one exemplary embodiment;

FIG. 2 is a block schematic diagram of the system in accordance with an embodiment in accordance with one exemplary embodiment;

FIG. 3 is a block schematic diagram of the system in accordance with one exemplary embodiment;

FIG. 4 is a flowchart of a method for facilitating communications in accordance with one exemplary embodiment; and

FIG. 5 is a flowchart of the method in accordance with one exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Referring to the Figures, wherein like numerals indicate like parts throughout the several views, a system 100 and methods 400, 500 of facilitating communication are shown and described herein.

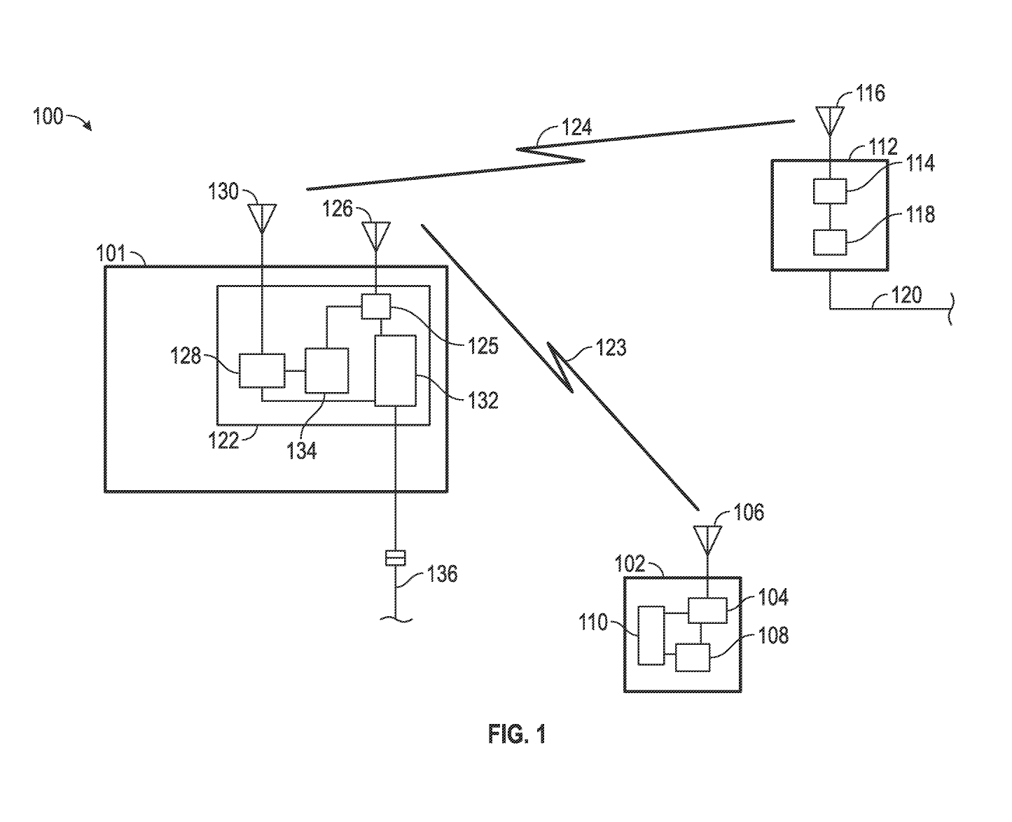

One exemplary embodiment of the system 100 is shown in FIG. 1. The system 100 includes a portable communications device 102. The portable communications device 102 of the exemplary embodiment is a handheld device allowing a user (not shown) to communicate with voice and/or data. The portable communications device 102 includes a radio 104 and an antenna 106 configured to transmit and receive radio frequency (“RF”) signals. The radio 104 may alternatively be referred to as a transceiver, as is appreciated by those skilled in the art.

The portable communications device 102 also includes a controller 108 in communication with the radio 104. The controller 108 is configured to control the radio 104 and transfer data therebetween. The controller 108 may include any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Those skilled in the art also appreciate that the radio 104, antenna 106, and/or controller 108 may be separate components or integrated with one another as a unitary component.

The portable communications device 102 of this embodiment also includes a battery 110. The battery 110 is electrically connected to the radio 104 and the controller 108 for supplying power to each. The portable communications device 102 may be referred to as a cellular phone, a cell phone, a smart phone, a mobile phone, a mobile, tablet, and/or a walkie-talkie. Those skilled in the art appreciate other devices that may function as the portable communications device 102.

The system 100 also includes a base station 112. The base station 112 of the exemplary embodiments is a wireless telephone base station having a radio 114 and an antenna 116 configured to transmit and receive radio frequency (“RF”) signals. The kind of base station 112 may include, but is certainly not limited to, Macro, Micro, Pico, and Femto cells. The base station 112 may also be a remote radio head serving a remote digital processing unit (not shown). The variety of the multiple base stations 112, sometimes referred to as “network end points”, address various deployment schemes for outdoor, indoor, urban, rural, and other types of environments.

The base station 112 also includes a controller 118 in communication with the radio 114 to control the radio 114 and transfer data therebetween, as is appreciated by those skilled in the art. The controller 118 may include one or more processors, e.g., microprocessors, as is also appreciated by those skilled in the art. The base station 112 is also in communication with a telecommunications network 120 and configured to transfer data to and from the telecommunications network 120, as is also appreciated by those skilled in the art. The telecommunications network 120 may utilize wireless communications techniques (e.g., RF signals) and/or physical media (e.g., electrically conductive wire and/or fiber-optic cables). The controller 118 may be located remotely (not shown) from the base station 112 while controlling operation of the base station 112. For instance, control signals may be transmitted from the remotely located controller 118 via the telecommunications network 120.

The system 100 further includes a vehicle-based communications device 122, referred to hereafter as simply a vehicle-based device 122. The vehicle-based device 122 of the exemplary embodiments is associated with a vehicle 101, such as an automobile. However, other suitable vehicles 101 may alternatively be utilized to carry the vehicle-based device 122, including, but not limited to, a motorcycle, a train, a boat, and an aircraft.

The vehicle-based device 122 is configured to communicate with the portable device 102 via a first communications link 123 and communicate with the base station 112 via a second communications link 124. In the one exemplary embodiment, the communications links are implemented wirelessly utilizing RF signals. Accordingly, as shown in FIG. 1, the vehicle-based device 122 includes a first radio 125 with a first antenna 126 and a second radio 128 with a second antenna 130.

The vehicle-based device 122 also includes a controller 132 and a battery 134. The controller 132 may include one or more processors, e.g., microprocessors, as is appreciated by those skilled in the art. The controller 132 is configured to relay data between the first communications link 123 and the second communications link 124. As such, the vehicle-based device 122 acts as a relay or a “repeater” between the portable-device 102 and the base station 112. The battery 134 may be the same device that supplies power to the vehicle 101 or, alternatively, may be a separate and distinct component.

In some embodiments, a first communications protocol associated with the first communications link 123 is different from a second communications protocol associated with the second communications link 124. Also, in some embodiments, a first frequency band associated with the first communications link 123 is different from a second frequency band associated with the second communications link 124.

For example, in the one exemplary embodiment, the first communications link 123 is implemented utilizing a Wi-Fi connection. That is, the first communications link 123 is implemented utilizing frequencies and protocols associated with one or more of the IEEE 802.11 family of standards. Also in this embodiment, the second communications link 124 is implemented utilizing a mobile network. For example, the second communications link 124 is implemented utilizing frequencies and protocols associated with GSM, UMTS, and/or LTE standards. Of course, in other embodiments, the communications links 123, 124 may be implemented with any suitable frequencies and/or communications standards. Although the portable device 102 is shown in the figures as being located outside of the vehicle 101, it should be appreciated that the portable device 102 may be located inside the vehicle 101 as well.

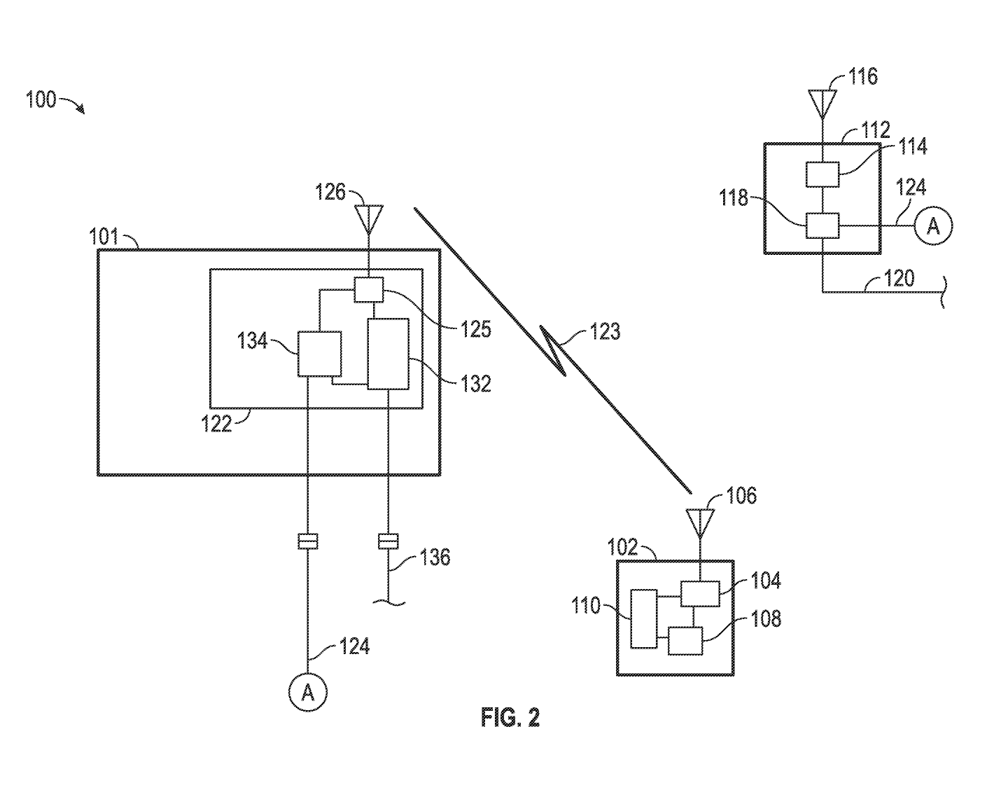

In the exemplary embodiment shown in FIG. 2, the second radio 128 and antenna 130 are not utilized. Instead, the second communications link 124 is established through physical media, e.g., electrically conductive wires and/or fiber-optic cables along with associated switching and/or routing equipment, as is readily appreciated by those skilled in the art.

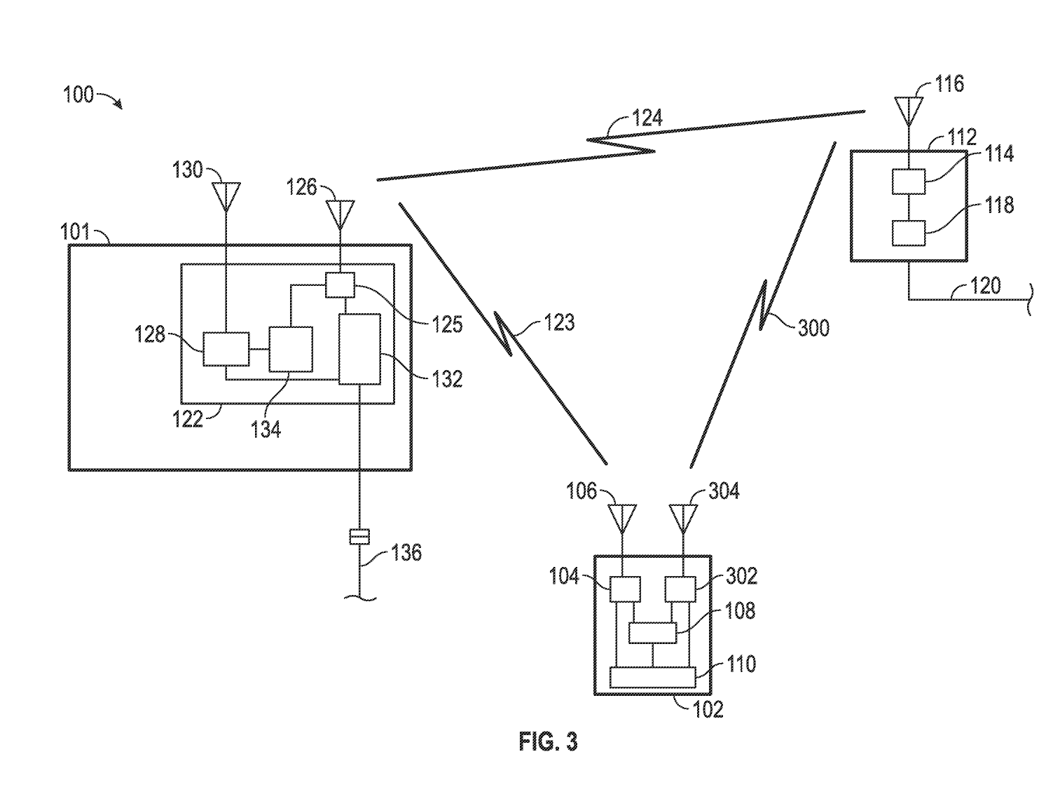

The portable device 102 may also communicate directly with the base station 112. Referring to the exemplary embodiment shown in FIG. 3, the portable device 102 is configured to communicate wirelessly via a third communications link 300 between the portable device 102 and the base station 112. In this embodiment, the third communications link 300 is implemented utilizing a second radio 302 and a second antenna 304 to communicate via a mobile network. Of course, other suitable devices, protocols, and/or frequencies may be utilized to establish the third communications link 300. Furthermore, the second communications link 124 and the third communications link 300 may utilize the same standard protocol, e.g., LTE. In such an instance, a single radio and antenna (not shown) of the portable device 102 may be utilized to establish both the second and third communications links 124, 300.

The disclosed methods of facilitating communications may utilize the exemplary systems 100 described above. However, it is to be appreciated that the methods described herein may be implemented utilizing devices and components other than those expressly described above.

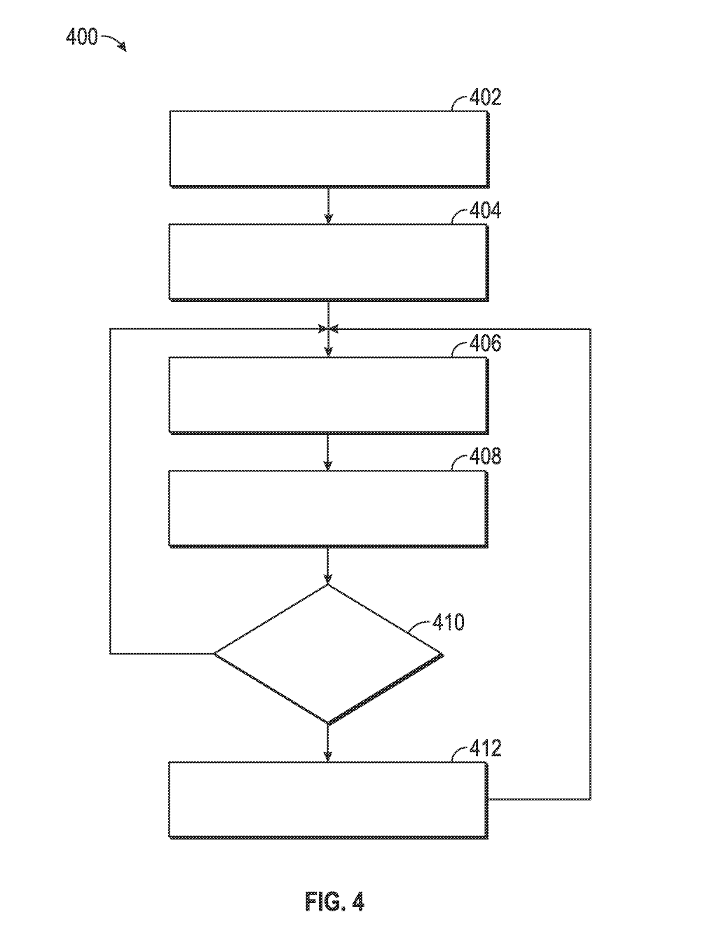

Referring to FIG. 4, and with continued reference to FIGS. 1-3, a first method 400 of facilitating communications includes, at 402, establishing a second communications link 124 between the vehicle-based device 122 and the base station 112. The method 400 further includes, at 404, establishing the first communications link 123 between the portable device 102 and the vehicle-based device 122.

The first method 400 further includes, at 406, relaying data between the first communications link 123 and the second communications link 124. Relaying data refers to the receipt and then transmission of data. For instance, when a packet of data is received at the vehicle-based device 122 from the portable device 102, that packet of data may be transmitted to the base station 112 from the vehicle-based device 122. Likewise, when a packet of data is received at the vehicle-based device 122 from the base station 112, that packet of data may be transmitted to the portable device 102 from the vehicle-based device 122. However, not all data need be automatically relayed. For example, some packet header information and other “housekeeping” data need not be relayed. Furthermore, different packet header information may be attached to the data during the relay process, depending on the protocol, frequency, encryption techniques, and other conditions, as is appreciated by those skilled in the art.

In some embodiments, prior to establishing the first communications link 123, the portable device 102 may be in communication directly with the base station 112. As such, after establishing the first communications link 123, the direct communications between the portable device 102 and the base station 112 may be terminated.

In some embodiments, establishing communication links 123, 124 or relaying of data may be subject to certain other constraints. For example, in one embodiment, the first method may include (not shown in FIG. 4) sensing an operational state of the vehicle 101 associated with the vehicle-based device 122. In this one embodiment, establishing the second communications link 124 is only done in response to the operational state of the vehicle 101 being a parked state. The parked state may be indicated by, for example, an automatic transmission being placed in “park”, the parking brake engaged, and/or the vehicle 101 stopped for a predetermined amount of time. Of course, relaying of data is not necessarily limited to when the vehicle 101 is stopped or parked.

In another embodiment, the method may include (not shown in FIG. 4) sensing a charging state of the vehicle 101 associated with the vehicle-based device 122. For instance, with electric-powered and/or hybrid vehicles, the battery 134 may be charged using a utility power source 136 when not in use. In this embodiment, establishing the second communications link 124 is only done in response to the charging state being active, i.e., when the vehicle 101 is plugged in to the utility power source 136.

With continued reference to FIG. 4, the first method 400 includes, at 408, determining a quality of the first communications link 123 and the second communications link 124. Determining a quality of the communications links 123, 124 may be achieved using the controller 108 of the portable device 102 with one or more techniques, as described below. However, determining of the quality may be performed remote from the portable device 102 or in multiple locations. For instance, the determining of the quality may be performed by the controller 132 of the vehicle-based device 101 and/or the controller 118 of the base station 112. The determined quality of the communications links 123, 124 may be transferred between the various devices 102, 101, 112 via the communications links 123, 124.

In one technique of determining the quality of the communication links 123, 124, measuring the data transfer rate of the first and second communications links 123, 124 is utilized to determine the quality of the first and second communications links 123, 124. For example, if the data transfer rate, i.e., the number of bits per second received by the portable device 102, is at or near a maximum data rate for the protocol, such a data transfer rate is indicative of a high quality of the first and second communications links 123, 124. Another technique utilizes an error rate of communications. For example, if data transferred over the first and second communications links 123, 124 is achieved with numerous errors, a low quality of the first and second communications links 123, 124 is indicated. In yet another technique, signal strengths of the RF signals received at the portable device 102, the vehicle-based device 122, and the base station 112 may be analyzed. Yet another technique utilizes a signal-to-noise-ratio metric. For example, if the signal-to-noise-ratio over the first and second communications links 123, 124 is measured from the corresponding radios 104, 125, 128, 114, a low quality of the first and second communications links 123, 124 is indicated by the minimal signal-to-noise-ratio accordingly.

The first method 400 also includes, at 410, determining whether the quality of the first communications link 123 is higher than a predetermined threshold. For example, if the quality of the first communications link 123 is determined solely by the data transfer rate, then determining the quality of the first communications link 123 may be implemented by determining if the data transfer rates of this link 123 is higher than a predetermined threshold.

If the quality of the first communications link 123 is higher than the predetermined threshold, then the method 400 includes, at 412, reducing an emitted power of the portable device 102 in response to the quality of the first communications link 123 being higher than the predetermined threshold. In one embodiment, the predetermined threshold may be equivalent to the difference between quality of the communications links 123, 124 For example, if the signal-to-noise-ratio for the first communications link 123 is higher by 10 dB with respect to the signal-to-noise-ratio for the second communications link 124, this implies that the transmission power of the portable device 102 can potentially be reduced by up to 10 dB. Thus, the predetermined threshold is 10 dB less than the signal-to-noise ratio of the first communications link 123.

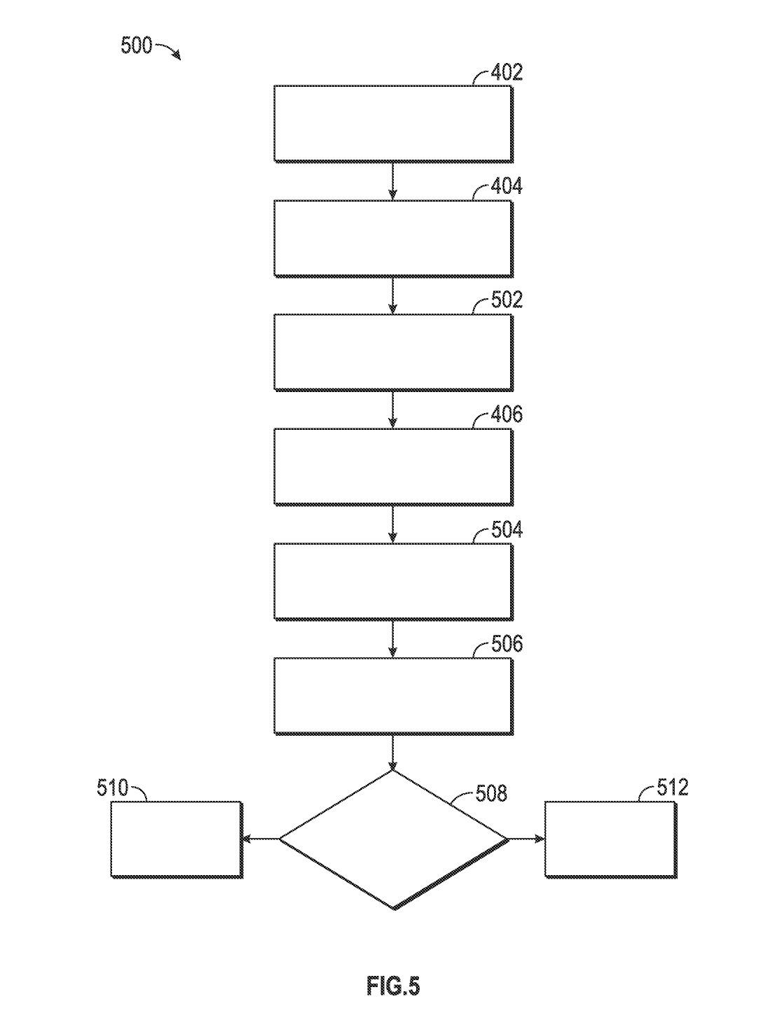

Referring to FIG. 5, an exemplary method 500 of facilitating communications includes, at 402, establishing the first communications link 123 between the portable device 102 and the vehicle-based device 122. The second method 500 further includes, at 404, establishing the second communications link 124 between the vehicle-based device 122 and the base station 112. The second method 500 also includes, at 502, establishing the third communications link 300 between the portable device 102 and the base station 112. The second method further includes, at 406, relaying data between the first communications link 123 and the second communications link 124.

Once the first communications link 123 is established, the second method 500 includes, at 504, determining a power requirement of the portable device 102 utilizing the first communications link 123. For example, the portable device 102 may calculate the rate of power drain of the battery 110 for one or more usage scenarios utilizing the first radio 104 and the first communications link 123.

Once the third communications link 300 is established, the second method 500 includes, at 506, determining a power requirement of the portable device 102 utilizing the third communications link 300. For example, the portable device 102 may calculate the rate of power drain of the battery 110 for one or more usage scenarios utilizing the second radio 302 and the third communications link 300.

The method 500 also includes, at 508, determining which of the first and third communications links 123, 300 utilizes the least amount of power. This determination may be accomplished by hardware and/or software of the portable device 102, the base station 112, and/or the vehicle-based device 122. If it is determined that the power requirement of the portable device 102 utilizing the first communications link 123 is greater than the power requirement of the of the portable device 102 utilizing the third communications link 300, then the method 500 includes, at 510, terminating the first communications link 123. Alternatively, if it is determined that the power requirement of the portable device 102 utilizing the third communications link 300 is greater than the power requirement of the of the portable device 102 utilizing the first communications link 123, then the method 500 includes, at 512, terminating the third communications link 300.

In other embodiments, a selection between the first and third communications links 123, 300 may be due to factors other than power requirements. For instance, the selection may be due to network control decisions such as load balancing and/or admission control.

The method 500 may be repeated periodically to evaluate changes in the power requirements of the portable device 102 in conjunction with the first and third communications links 123, 300.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of facilitating communications, comprising:
establishing a first communications link between a portable device and a vehicle-based device;
establishing a second communications link between the vehicle-based device and a base station;
relaying data between the first communications link and the second communications link;
determining a quality of the first communications link and the second communications link; and
reducing an emitted power of the portable device in response to the quality of the first communications link and the second communications link being higher than a predetermined threshold.

2. The method as set forth in claim 1, further comprising:
sensing an operational state of a vehicle associated with vehicle-based device,
wherein establishing the second communications link comprises establishing the second communications link in response to the operational state being a parked state.

3. The method as set forth in claim 1, further comprising:
sensing a charging state of a vehicle associated with vehicle-based device,
wherein establishing the second communications link comprises establishing the second communications link in response to the charging state being active.

4. The method as set forth in claim 1, wherein the predetermined threshold is generally equivalent to a difference between the quality of the first communications link and the quality of the second communications link.

5. The method as set forth in claim 1, wherein the second communications link is established utilizing radio frequency (RF) signals.

6. The method as set forth in claim 1, wherein the second communications link is established utilizing signals transmitted through a physical media.

7. The method as set forth in claim 1, wherein a first communications protocol associated with the first communications link is different from a second communications protocol associated with the second communications link.

8. The method as set forth in claim 1, wherein the first and second links are established using radio frequency (RF) signals and a first frequency band associated with the first communications link is different from a second frequency band associated with the second communications link.

9. The method as set forth in claim 1, wherein
determining the quality of the first communications link comprises as measuring the data transfer rate of the first communications link; and
reducing an emitted power of the portable device comprises reducing an emitted power of the portable device in response to the data transfer rate of the first communications link being higher than a predetermined threshold.

10. A method of facilitating communications, comprising:
establishing a first communications link between a portable device and a vehicle-based device;
establishing a second communications link between the vehicle-based device and a base station;
establishing a third communications link between the portable device and the base station;
relaying data between the first communications link and the second communications link;
determining a power requirement of the portable device utilizing the first communications link;
determining a power requirement of the portable device utilizing the third communications link;
terminating the first communications link in response to the power requirement of the portable device utilizing the first communications link being greater than the power requirement of the portable device utilizing the third communications link; and
terminating the third communications link in response to the power requirement of the portable device utilizing the third communications link being greater than the power requirement of the portable device utilizing the first communications link.

11. A system for facilitating communications, comprising:
a portable device;
a base station; and
a vehicle-based device configured to communicate wirelessly via a first communications link with said portable device, communicate via a second communications link with said base station, and relay data between the first communications link and the second communications link;
wherein at least one of said portable device, said base station, and said vehicle-based device is configured to determine a quality of the first communications link; and
wherein said portable device is configured to reduce an emitted power in response to the quality of the first communications link being higher than a predetermined threshold.

12. The system as set forth in claim 10, wherein said vehicle-based device is further configured to sense an operational state of a vehicle associated with said vehicle-based device and establish the second communications link in response to the operational state being a parked state.

13. The system as set forth in claim 10, wherein said vehicle-based device is further configured to sense a charging state of a vehicle associated with said vehicle-based device and establish the second communications link in response to the charging state being active.

14. The system as set forth in claim 10 further comprising physical media utilized to establish the second communications link.

15. The system as set forth in claim 10, wherein a first communications protocol associated with the first communications link is different from a second communications protocol associated with the second communications link.

16. The system as set forth in claim 10, wherein the first and second communications links are established using radio frequency (RF) signals and a first frequency band associated with the first communications link is different from a second frequency band associated with the second communications link.

17. The system as set forth in claim 10, wherein determining the quality of the first communications link by said portable device comprises measuring the data transfer rate of the first communications link and reducing an emitted power of the portable device comprises reducing an emitted power of the portable device in response to the data transfer rate of the first communications link being higher than a predetermined threshold.

18. The system as set forth in claim 10, wherein said portable device is further configured to communicate wirelessly via a third communications link between the portable device and the base station.

19. The system as set forth in claim 18, wherein said portable device is further configured to
determine a power requirement of said portable device utilizing the first communications link, and
determine a power requirement of said portable device utilizing the third communications link.

20. The system as set forth in claim 19, wherein said portable device is further configured to
terminate the first communications link in response to the power requirement of said portable device utilizing the first communications link being greater than the power requirement of said portable device utilizing the third communications link, and
terminate the third communications link in response to the power requirement of said portable device utilizing the third communications link being greater than the power requirement of said portable device utilizing the first communications link.
